(19) United States
(12) Patent Application Publication
(10) Pub. No.: US 2006/0067084 A1
(43) Pub. Date: Mar. 30, 2006

(54) Light guide for lights, in particular for motor vehicle lights

(75) Inventor: Emil Stefanov, Altbach (DE)

Correspondence Address: Warn, Hoffmann, Miller & LaLone, P.C., P.O. Box 70098, Rochester Hills, MI, 48307, US

(73) Assignee: Schefenacker Vision Systems Germany GmbH, Esslingen (DE)

(21) Appl. No.: 11/231,463

(22) Filed: Sep. 21, 2005

(30) Foreign Application Priority Data
Sep. 24, 2004 (DE) 102004046386.7

(51) Int. Cl. F21V 9/00

(52) U.S. Cl. 362/511; 362/556

(57) ABSTRACT

Light guide for lights, in particular for motor vehicle lights. The light guide has a light source whose radiated light is directed out of the light guide at a light emission side by a reflective structure over at least a part of the length of the light guide. In order to design a light guide such that a desired luminance distribution can be achieved in a simple manner therewith, the proportion of reflective surface in a region of the reflective structure located closer to the light source is a smaller or larger part of the total reflective surface of the light guide than the proportion of reflective surface in a region of the reflective structure located further away from the light source. A desirable luminance distribution can be obtained easily in this way. The light guide is especially suitable for motor vehicle lights.

### CROSS-REFERENCE TO RELATED APPLICATIONS

This application claims priority to German Patent Application No. 10 2004 046 386.7 filed on Sep. 24, 2004.

### TECHNICAL FIELD

The invention concerns a light guide for lights, in particular for motor vehicle lights.

### BACKGROUND

Light guides are known in which the light emission surface is opposite a reflective surface having prisms located one behind the other, said prisms having a constant, generally symmetrical prism structure. Such light guides have the disadvantage that uniform luminance distribution or selectively oriented light intensity distribution is not possible over the length of the light guide.

The object of the invention is to design a light guide of this type such that a desired luminance distribution can be achieved in a simple manner with said light guide.

This object is attained in accordance with the invention in a light guide.

### SUMMARY

As a result of the inventive design, a desired luminance distribution can be obtained easily. By appropriate adjustment of the size of the reflective surfaces, the effect is achieved that the proportion of reflective surfaces, e.g., in the region next to the light source is smaller or larger than in a region further away. Since the light intensity is high in the region of the light source, a relatively small proportion of reflective surface suffices. The reflective surfaces located further away from the light source are present in a higher proportion in terms of percentage in order to reflect the lower proportion of light to the outcoupling side of the light guide. In this way, a luminance distribution of the radiated light can be obtained that is at least approximately uniform over the length of the outcoupling side of the light guide, for example. However, by appropriately dividing the proportion of reflective surfaces it is also possible to achieve the result that the light exits with specific luminances over the length of the outcoupling side of the light guide. In particular, as a result of the inventive design, the light can be purposefully directed such that light can efficaciously be coupled out in a predefined range of solid angles. In this way, a more uniform average luminance distribution along the light guide is achieved with respect to different observation positions. A legally mandated light intensity distribution can also be achieved easily in this manner.

The reflective structure is advantageously composed of prisms. In order to achieve a uniform luminance distribution while simultaneously fulfilling the requirements with respect to light intensity distribution, functional control of different prism parameters is carried out. Prism parameters can be locally varied in this way.

Additional features of the invention are apparent from the other claims, the description, and the drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention is explained in detail on the basis of two example embodiments shown in the drawings. In the drawings:

FIG. 1, shows a part of an inventive light guide in top view,

FIGS. 2 through FIG. 4, each show an enlarged view of a light guide section from FIG. 1,

FIG. 5, shows a second embodiment of an inventive light guide in a representation corresponding to FIG. 1,

FIGS. 6 through FIG. 9, each show different embodiments of light guide sections of the light guide.

### DETAILED DESCRIPTION OF THE PREFERRED EMBODIMENTS

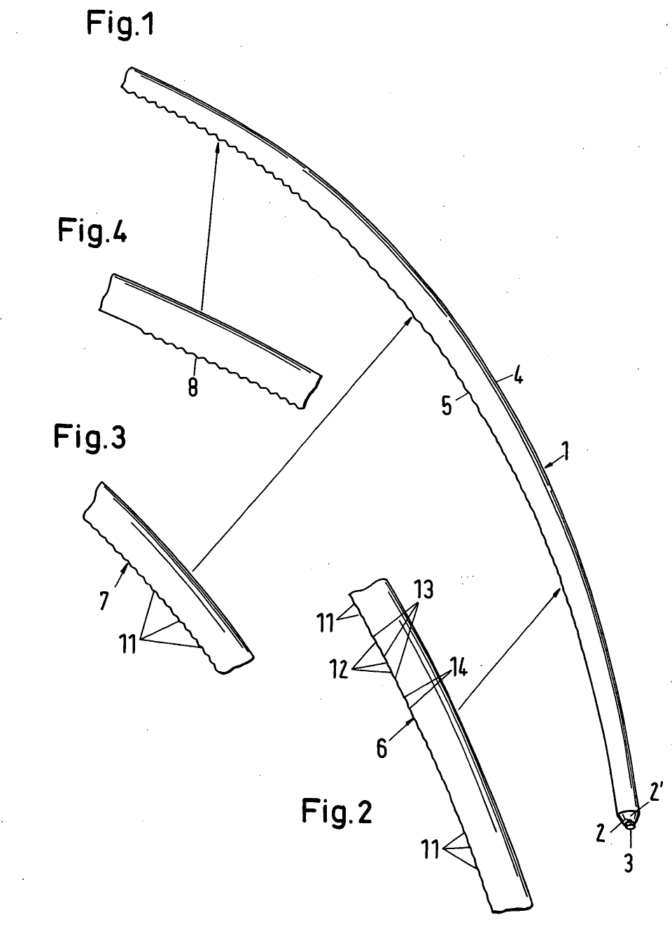

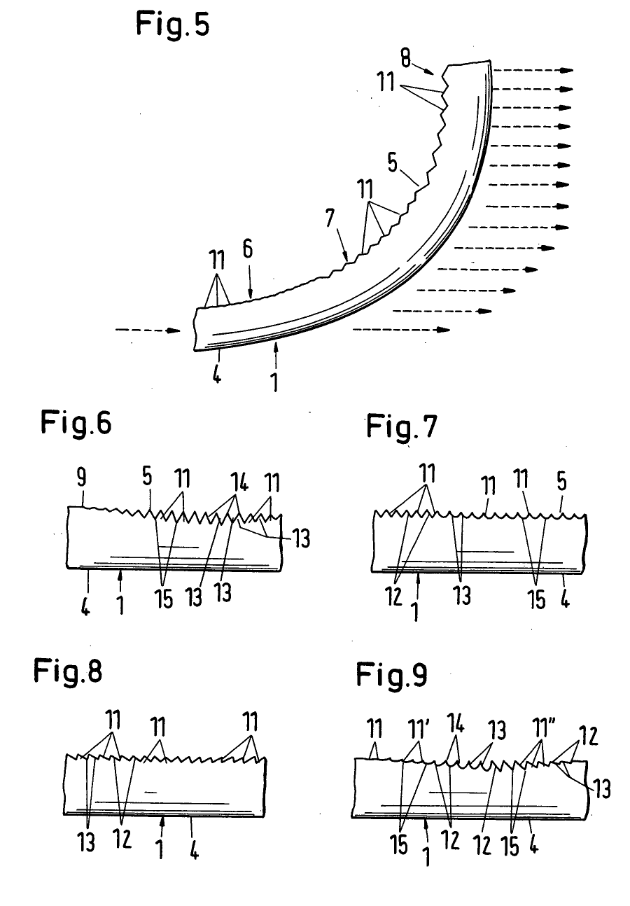

The light guides 1 shown in FIGS. 1 and 5 are intended for motor vehicle lights. They consist in a known way of light-guiding material and are designed, by way of example, as curved rods with one end designed as a light input surface 2 (FIG. 1). The light input surface is composed of a recess in the shape of a section of a sphere in which a lighting means 3, preferably an LED, is located. A different lighting means, as for example an incandescent lamp or the like, may also be provided in place of a light-emitting diode. The convex side 4 of the light guide 1 forms a light emission side, while the opposite concave outer surface forms a reflective side 5. The light rays emitted by the lighting means 3 are reflected to the light emission side 4 at the reflective side 5. The reflective side 5 has profilings or profile sections 6 to 8 of designs which differ along its length; their designs are shown in detail in FIGS. 2 to 4 and FIGS. 6 to 9.

The light guide 1 can also be designed such that the lighting means 3, in particular the LED, is molded into the material of the light guide 1. In this case, the relevant end of the light guide 1 does not constitute a light input surface 2, since the light emerges from the lighting means 3 within the light guide 1. Light guides 1 with light input surfaces 2 are described in the following; however, the described embodiments of the light guide 1 also apply to embodiments in which the lighting means 3 is molded into the material of the light guide 1.

In the example embodiments, the profile sections 6 to 8 are composed of individual prisms 11 connected to one another in the longitudinal direction of the light guide 1; in place of prisms, other reflective or dispersive bodies may of course also be provided. Preferably the prisms of the light guide profile sections 6 to 8 differ by, for example, their prism height, base width, asymmetry or inclination of their lateral surfaces 12, 13, the rounding of their edges 14, or the geometry of the incoupling points. All of these parameters or only isolated parameters may differ from one another. In addition, the position of the light source 3 relative to the reflective bodies or their lateral surfaces 12, 13 may also be varied. In all embodiments, the profile sections are implemented and arranged such that their prisms reflect the incident light more strongly with increasing distance from the light input surface 2 or from the lighting means 3 in order to compensate the light intensity of the emergent light, which diminishes with increasing distance from the lighting means 3, so that more uniform light distribution over the length of the light guide 1 is achieved.

Adjoining and expanding outward from the light input surface 2 is a total reflector region 2′, whose surface lines have a convex curvature. Some of the rays emitted by the lighting means 3 strike the walls of the total reflector region 2′, at which they are totally reflected. The region 2′ transitions into a profile section 6 (FIG. 2) having a wavelike profile with minimally pronounced prisms, which thus have a short prism height and whose lateral surfaces 12, 13 approach one another at relatively large obtuse angles, so the base width of these prisms 11 is correspondingly large. The transitions between the lateral surfaces 12, 13 may be rounded or they may also have edges 14. Preferably, at least the prism height of the prisms 11 increases with increasing distance from the lighting means 3 or the light input surface 2 within this profile section 6 as well.

In the region of the profile section 7 shown in FIG. 3, the prisms 11 are even more sharply pronounced than in the profile section 6. With increasing distance from the light input side 2 and with increasing distance from the profile section 6, the prisms 11 have a greater prism height and smaller base width, so their lateral surfaces 12, 13 are oriented to one another at smaller acute angles than in the profile section 6. The prism height increases further in the region of the profile section 8. The base width may also decrease further. It is also possible to leave the base width unchanged.

In all profile sections 6 to 8, prisms 11 of asymmetrical design may also be present. Such asymmetrical prisms, which are inclined away from or toward the light input surface 2, for example, are shown in FIGS. 6 to 9, as explained below. In addition, the prisms may be designed with sharp or rounded edges. As a result of the more sharply pronounced profiling of the reflective side 5 with increasing distance from the light input surface 2, the diminishing light intensity and luminance in this direction can be increased by increasing the proportion of the reflective surfaces 12, 13 of the profile sections 6 to 8 of the reflective surface as a whole.

As FIGS. 5-9 show, successive prisms 11 may also have clearly different heights, inclinations and/or edge forms.

As shown in FIG. 6, a region 9 having prisms of small height is adjoined by prisms 11 similar to those in FIG. 2, whose prism height sharply increases with increasing distance from the light input side 2 and which have small base width and sharp free edges 14 and a sharp-edged groove base 15. The relatively tall prisms 11 then transition into shorter prisms 11, which have the same base width and whose lateral surfaces 12, 13 have different heights. In this profile region, the reflective side 5 has an asymmetrical shape, achieving an optimal luminance distribution in each case and making it possible to adjust the outcoupling direction as desired for the emerging light depending on the geometric conditions of the light guide. In this embodiment, this is achieved through the function-driven prism heights.

FIG. 7 again shows a profile section of the reflective side 5, in which the prisms 11 have varying designs, in that function-driven prism rounding is used. In a first region, the prisms 11 have, similar to those in FIG. 6, a sharp-angled transition and in some cases lateral surfaces 12, 13 with varying length, while the prisms 11 provided in an adjoining section have shorter prism heights yet are rounded in a circular arc in their base region or groove base 15.

FIG. 8 shows a profile section with function-driven prism inclination. In this profile section, the prisms 11 have different inclinations. In a first section, the prisms in the drawing are inclined to the left, and in a right-hand section of FIG. 8 they are inclined to the right. In the prisms 11 located between these sections, the differences in the lengths of the lateral prism surfaces 12, 13 are less pronounced. In the left-hand section, the lateral prism surfaces 12 have a greater length than the other lateral prism surfaces 13. In the region between the prisms 11 that are inclined in different directions, some approximately symmetrical prisms 11 are provided in the example embodiment.

In the embodiment in FIG. 9 a combination of function-driven prism parameters such as height, inclination, and rounding are employed. A region with only very small profile height is adjoined by prisms that are increasingly pronounced, and thus have greater prism height and are of asymmetrical design. This transition region is adjoined in turn by a region with prisms which, like those in the first region, have only very small height, and thus are hardly recognizable. The prisms 11′ that adjoin the region of minimally pronounced prisms on the left in FIG. 9 have a rounded groove base 15, but transition to the lateral surfaces 12, 13 through sharp edges 14. These asymmetrically designed prisms 11′ are inclined to the right in FIG. 9. This section of prisms 11′ inclined to the right transitions to a section of prisms inclined to the left, in which the prisms 11″ have a sharp-edged groove base 15. Their lateral surfaces 13 are longer than the other lateral surfaces 12. In the region adjacent to the prisms 11′, the prisms 11″ have greater prism height, which then decreases toward the right in FIG. 9. The transitions between the different prism regions are advantageously smooth, but can also be abrupt in appropriate application cases.

Naturally, any desired transformations of the prism shape and arrangement, by changing the prism height, inclination, rounding, spacing, etc., are conceivable. As already mentioned, other reflective bodies can also be provided in place of the prisms. By suitable design and arrangement of these reflective bodies, the light distribution and light intensity or luminance can be improved such that the light guide 1 radiates light uniformly. In every case, the proportion of the reflective surface of the light guide 1 in its part adjacent to the light input surface 2 is smaller, relative to the total reflective surface of the light guide 1, than in the other regions. In order for the regions located further from the light input side 2 or the lighting means 3 to still radiate sufficient light to the outside despite decreasing luminance, the proportion of reflective surface there is greater relative to the total reflective surface than in the light input region.

The example embodiments described are not to be interpreted in a limiting manner, but instead are intended to illustrate that adaptation to the desired application goal is possible through selective control of light parameters such as prism height, prism base width, prism asymmetry (inclination) and prism edge radii, cross-sectional geometry or incoupling point geometry, light source position, and the like. The various designs of the prisms can be achieved through suitable functional distributions, as for example higher order polynomials, trigonometric functions, exponential functions, and/or other continuous or discontinuous functions and combinations of these functions. In this way, the light intensity distribution and luminance distribution is better adapted to the specified requirements; in particular, light outcoupling efficiency and perception and their effect are purposefully improved.

The generating parameters for adjacent outcoupling elements 11 vary such that optimized or optimal functional distributions are achieved. The light guide parameters described can be varied independently of one another. Thus, it is possible to change or vary only one light guide parameter. However, it is also possible to change two or more light guide parameters. A very wide variety of combinations of light guide parameters is possible in this regard.

The inventive light guides can be used not only for motor vehicle lights, but also can be used for interior and exterior lighting of marker lights or integrator lights. Also conceivable are any desired free-form lights, used for advertising or signaling, for example.

As is evident from the example embodiments described, a selective light intensity distribution, an efficacious outcoupling of light in a predefined range of solid angles, and a uniform luminance distribution along the light guide 1 with respect to various observation positions may be set.

The prism base width is advantageously only approximately 1 mm. Even at a spacing of approximately 1.5 mm, the prisms can no longer be resolved by the human eye. The light guide 1 then has the appearance of a smooth, continuous rod.

The description of the invention is merely exemplary in nature and, thus, variations that do not depart from the gist of the invention are intended to be within the scope of the invention. Such variations are not to be regarded as a departure from the spirit and scope of the invention.

1. Light guide for lights, of a motor vehicle, comprising at least one light source whose radiated light is directed out of the light guide at a light emission side by a reflective structure over at least a part of the length of the light guide, wherein the proportion of reflective surface in a region of the reflective structure located closer to the light source is a smaller or larger part of the total reflective surface of the light guide than the proportion of reflective surface in a region of the reflective structure located further away from the light source.

2. Light guide according to claim 1, wherein the proportion of reflective surface increases continuously.

3. Light guide according to claim 1, wherein the proportion of reflective surface increases by sections.

4. Light guide according to claim 1, wherein the proportion of reflective surface increases within a section of the light guide.

5. Light guide according to claim 1, wherein the reflective structure is composed of prisms.

6. Light guide according to claim 6, wherein the prisms have different cross-sectional shapes.

7. Light guide according to claim 5, wherein the prisms located closer to the light source have a smaller reflective surface than the prisms located a greater distance away from the light source.

8. Light guide according to claim 5, wherein the reflective surface of neighboring prisms increases with increasing distance from the light source.

9. Light guide according to claim 5, wherein the prisms within a region of the light guide have reflective surfaces of equal size, and in that the sizes of the reflective surfaces of adjacent regions are different.

10. Light guide according to claim 5, wherein the prisms differ from one another with regard to their height and/or their base width and/or their asymmetry and/or inclination and/or edge radii.

11. Light guide according to claim 5, wherein adjacent reflective surfaces transition into one another in an acute angle and/or in a rounded manner.

12. Light guide according to claim 5, wherein the prisms are inclined in the same and/or opposite directions with respect to one another.

13. Light guide according to claim 5, wherein the prisms have a symmetrical cross-sectional shape.

14. Light guide according to claim 5, wherein the prisms have an asymmetrical cross-sectional shape.

15. Light guide according to claim 5, wherein the parameters of the prisms are selected on the basis of function.
